(19) United States
(12) Patent Application Publication
(10) Pub. No.: US 2009/0055373 A1
(43) Pub. Date: Feb. 26, 2009

(54) System and method for refining search terms

(76) Inventor: Irit Haviv-Segal, Tel-Aviv (IL)

Correspondence Address: Pearl Cohen Zedek Latzer, LLP, 1500 Broadway, 12th Floor, New York, NY, 10036, US

(21) Appl. No.: 11/797,956

(22) Filed: May 9, 2007

Related U.S. Application Data
(60) Provisional application No. 60/746,850, filed on May 9, 2006.
(60) Provisional application No. 60/866,217, filed on Nov. 17, 2006.

(51) Int. Cl. G06F 7/06; G06F 17/30

(52) U.S. Cl. 707/5; 707/3; 707/E17.069

(57) ABSTRACT

A system and method for refining a string of search term used in a search of an electronic data base, by extracting phrases from a first result set of the search, selecting relevant phrases from among the extracted phrases, and adding the selected phrases to the original search term.

### REFERENCE TO RELATED APPLICATIONS

This application claims benefit of U.S. Provisional Patent Application No. 60/746,850, filed on May 9, 2006 entitled ‘A Robot for Optimizing Search-Phrases, and from U.S. Provisional Patent Application No. 60/866,217, filed on Nov. 17, 2006, entitled The Boolean Search Robot, both of which are incorporated by reference herein in their entirety.

### FIELD OF THE INVENTION

The present invention generally relates to searching an electronic data base. More particularly, the invention relates to a system and method of refining the search terms used in a search of an electronic data base

### BACKGROUND OF THE INVENTION

A search engine may be used for searching a data base of electronic text, data or other information. Compiling accurate search terms may be essential to identifying the sought documents and excluding extraneous files from the search results. Many users of search engines are unwilling or unable to refine the search terms they use, and are therefore burdened with large quantities or search results, much of which is irrelevant or unrelated to their intended search target.

### SUMMARY OF THE INVENTION

In some embodiments, the invention may include a method of loading into a memory a first result set of an electronic data base search, where the search is executed using a first search phrase, assembling a list of additional phrases collected from the first result set, presenting the list to a user for selection of a second search phrase, adding the second search phrase to the first search phrase with a Boolean connector.

In some embodiments, the electronic data base search is a first electronic data base search, and there is performed a second electronic data base search using the second search phrase and the first search phrase.

In some embodiments, the second electronic data base search is executed on the result set.

In some embodiments, the second electronic data base search is executed on the electronic data base.

In some embodiments, the assembling includes identifying words in the first result set that are proximate to the first search phrase.

In some embodiments, the identifying words includes identifying phrases of words that are proximate to the first search phrase, where the phrases are of one to three words in length.

In some embodiments, the assembling includes ranking an additional phrase on the list according to a number of times that the additional phrase appears in the result set proximate to the first search term.

In some embodiments, the assembling includes identifying at least additional phrases that are synonymous to each other.

In some embodiments, there is performed a summing of a relevance ranking of at least two synonymous phrases.

Some embodiments include assigning a title to two synonymous phrases based on a word of a first phrase of the two synonymous phrases, such first phrase having a highest relevance ranking from among the two synonymous phrases.

Some embodiments include adding as the second search phrase at least two of the synonymous phrases, and includes adding with an AND Boolean connector the second phrase to the first phrase, and connecting the synonymous phrases to each other with an OR connector.

Some embodiments includes excluding from the list phrases that are synonymous with the first search phrase.

Some embodiments included adding to the first search phrase with an OR connector, phrases from first result set that are synonymous with the first search phrase.

In some embodiments, the first result set is derived from summaries of texts in the electronic data base that were found in the first search.

Some embodiments include assembling the list of additional search phrases from the first result set and from a predefined compendium of search phrases.

Some embodiments include determining that a first phrase is synonymous with a second phrase by determining if a number of identical letters in the first phrase and the second phrase is above a pre-defined limit; and if the number is above the pre-defined limit, determining if an ordered letter group in the t phrase matches an ordered letter group in the second phrase.

Some embodiments include determining if an ordered letter group in the first phrase matches an ordered letter group in the second phrase, where the ordered letter groups are at least three letters long.

In some embodiments an ordered letter group in a first phrase may be deemed to match an ordered letter group in a second phrase even if there is an intervening letter in one or the letter groups that does not appear in the other letter group.

In some embodiments, a method may present to a user phrases collected from a result set of a first search of an electronic data base, the first search used a first search phrase, and may add a phrase selected by the user from the phrases collected from the result set, to the first search phrase, and may execute a second search using the first search phrase and the phrase selected by said user.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic depiction of a system in accordance with an embodiment of the invention;

FIG. 2A is a table showing a user-devised phrase and a list of extracted phrases along with a count of the appearances of such extracted phrases in a result set in accordance with an embodiment of the invention;

FIG. 2B shows a table of a list of extracted phrases whose rankings have been adjusted and which may be displayed for a user, and further showing synonymous phrases grouped together into categories or hidden from view of a user, in accordance with an embodiment of the invention;

FIG. 3 is a flow chart of a method of adjusting rankings of extracted words, in accordance with an embodiment of the invention;

FIG. 4 is a depiction of an array into which words and letters of a source phrase and a compared phrase may be loaded, in accordance with an embodiment of the invention;

FIG. 5 is a flow chart of a method detecting synonymous phrases, in accordance with an embodiment of the invention;

FIG. 6 is a flow chart of a method in accordance with an embodiment of the invention; and

FIG. 7 is a flow chart of a method in accordance with an embodiment of the invention.

### DETAILED DESCRIPTION OF THE PREFERRED EMBODIMENTS

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “selecting,” “evaluating,” “processing,” “computing,” “calculating,” “associating,” “determining,” “designating,” “allocating” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition to its regular meaning the term phrase in this application may include a one-word phrase, a two-word phrase or a phrase of some other number of words.

In some embodiments, the invention may be embodied as a series of instructions that may be stored on an article of memory, such that when the instructions are executed on a processor, a method of the memory may be practiced.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored on an article such as a memory device, where such instructions upon execution result in a method of an embodiment of the invention. In some embodiments, one or more of the functions described in for example a method of the invention may be contained in a single device, while in other embodiments, one or more of such components may be stored or executed from more than one device. In some embodiments, components used in a system or method of the invention may be located proximately to each other, while in other cases the components such as memory or processing power may be distributed over a wide area, and linked for example via a network.

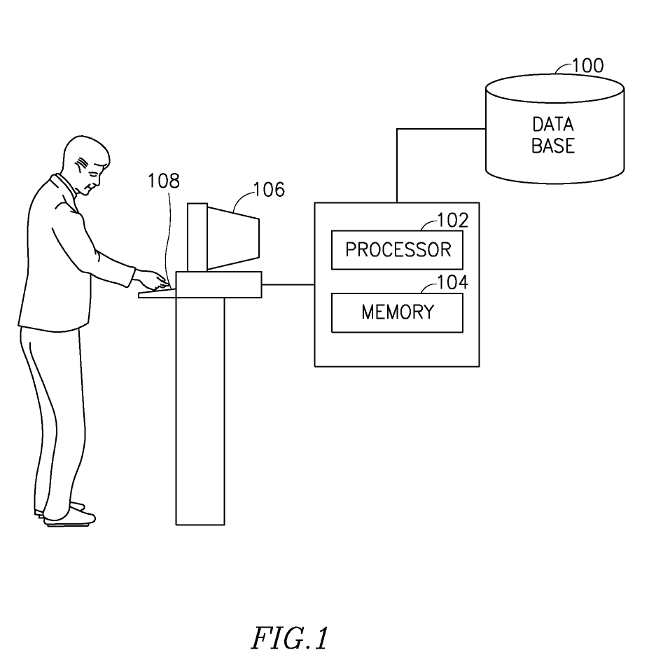

Reference is made to FIG. 1, a schematic depiction of a system in accordance with an embodiment of the invention. In some embodiments, a data base 100 may store in for example an electronic format, files that may contain or include text, data, images or other information. Data base 100 may be distributed over one or numerous memory devices such as disk drives, tapes or other mass data storage facilities, such as the Internet. Other localized data bases 100 are possible. Data base 100 may be linked to for example one or more processors 102 that may store and execute a search algorithm such as for example a search engine. Processor 102 may be linked or connected to one or more memory 104 units that may store for example a result set of a search and for example sample search terms. Processor 102 and memory 104 may be connected to or accessible by a user who may input data or search terms through an input 108 device such as a keyboard, mouse or other pointing device, and who may view terms, documents, selections or results on a display. In some embodiments, a first result set may be stored on a memory 104 that is connected to or part of a computer of a user.

In operation, a user may devise a search term to be used in a search of data base 100. Processor 104 may execute a search of some or all of the data base 100 using the devised search term. Some or all of the first result set of the search, in the form of for example a collection of files, documents, data, images, summaries, headings titles or a combination of the above, may be stored in for example memory 104. One or more phrases of between one to three proximate words in length, excluding inert words that may be included in the first result set may be derived, extracted, assembled from the first result set. The phrases may be ranked, sorted, or otherwise ordered by one or more factors, and one or more of the phrases that were found in the result set may be presented to a user. The user may select from among the presented phrases, the one or more phrases that is relevant to topic for which the user was searching. The selected phrase or phrases may be added to the original user-devised search term by way of an AND connector or other a Boolean connector, and the search may be run again using the expanded or refined search string which includes the selected terms. The search may be run on the result set that was stored on memory 104, or for example may be run on the entire data base 100 from which the result set was obtained.

In some embodiments, synonyms of the user-devised search term may be identified in the result set, and some or all of such synonyms may be added to the devised search term using OR connectors, or through other Boolean connectors to indicate that the search engine should include in a second result set, documents that include either or any of the synonymous terms.

In some embodiments, the selected extracted phrase, and some or all of its synonyms, may be added to the search string in front the user devised phrase, since many web search engines assign weight to the order of words in a search string.

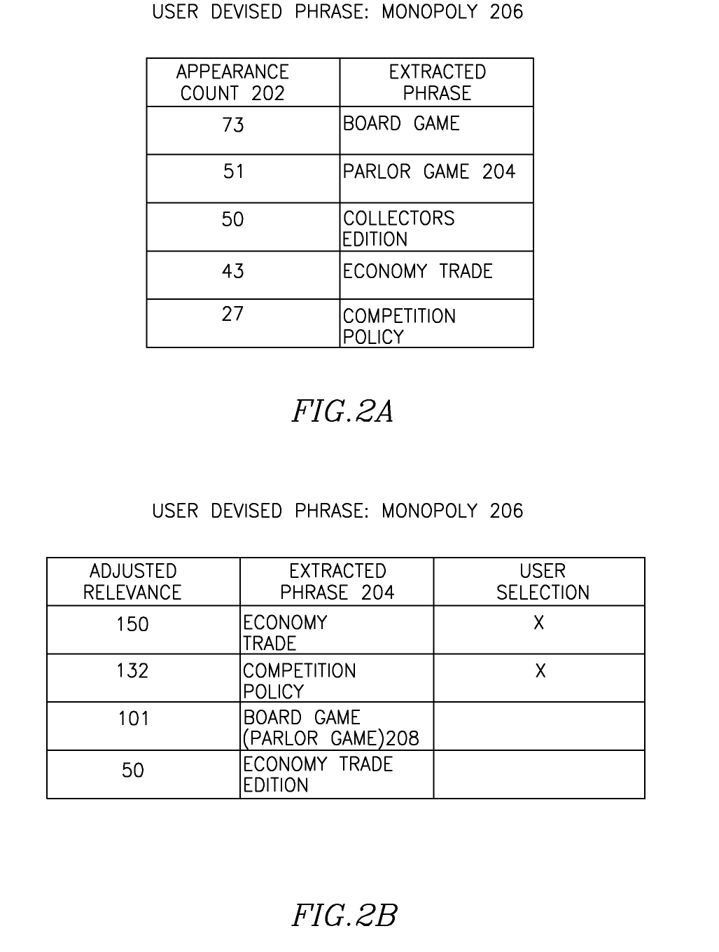

Reference is made to FIG. 2A, a table showing a user-devised phrase and a list of extracted phrases along with a count of the appearances of such extracted phrases in a result set in accordance with an embodiment of the invention. In some embodiments, a set of instructions may be executed by a processor such as processor 102, to extract, designate or list all phrases that are for example one to three words in length, and that for example fall within for example five or ten words either before or after one or more words in the user-devised search term. Other numbers may be used and other criteria may be used to extract phrases from the result set. In some embodiments, inert words, such as articles (‘the’ ‘a’ ‘some’), prepositions (‘its’ ‘his’ ‘hers’ ‘our’) and other words considered not meaningful or non-significant may be removed from the extracted phrases or not considered in the calculations used to extract phrases. In some embodiments, the inert or other words to be excluded from phrases may be so excluded before the phrases are loaded into the list of extracted phrases.

In some embodiments, a list or table 200 of extracted phrases from the result set may be ordered by their assumed relevance or meaningfulness to the user-devised search phrase. In some embodiments, the assumed relevance may be calculated by the number of times that the extracted phrase 204 appears in a pre-defined proximity to the user-devised phrase in the summaries of the documents or files making up the result set. For example, using a proximity measure of 10 words either before or following a word in a user-devised phrase, it may be found that an extracted phrase appears 25 times in proximity with one or more of the words in the user devised phrase. A count 202 of such proximate appearances of the extracted phrase in the result set may be kept, and such count may be linked or associated with the extracted phrase, and the relative relevance of the extracted phrase as compared to other extracted phrases may be ranked or ordered.

For example, if a user devised phrase 206 used by a user in a first search of a database is ‘monopoly’, a search may produce for example for phrases as extracted phrases 204 from the texts or files in the result set. A first extracted phrase 204 ‘board game’ may have appeared 73 times in the result set in a pre-defined proximity to the source phrase 206. A second extracted phrase 204 ‘parlor game’ may have appeared 51 times in the result set in proximity to the user devised phrase 206. A third extracted phrase ‘collectors edition’ 204 may have appeared 50 times in the result set. Other extracted phrases may also appear on the table 200. Other data structure besides a table may be used.

In some embodiments, a result set may include all of the text in a file wherein the user devised phrase 206 occurred. In some embodiments the result set may be limited to a summary or title of the files in the result set. In some embodiments, the extracted phrases may be ranked or sorted by their appearance count.

In another example, if a first result set includes the words “sam's interest in becoming a doctor”, an embodiment of the invention may extract inert words, as follows: “sam's interest in becoming a doctor”, to yield “sam interest becoming doctor”. An embodiment of the invention may then calculate a frequency factor or appearance count 202 for the words or phrases appearing in this text, as follows:

| | |
|---|---|
| Sam | +1 |
| Interest | +1 |
| Becoming | +1 |
| Doctor | +1 |
| Sam interest | +1 |
| Sam interest becoming | +1 |
| Interest becoming | +1 |
| Interest becoming doctor | +1 |
| Becoming doctor | +1 |

The appearances of the words or phrases listed above may be added to a count 202 of the appearances of these same words or phrases elsewhere in the result set, as such may be stored on a frequency table or elsewhere. When frequencies of phrases in the result set have been input into a frequency table 200, a sample table using the above example may appear as follows:

| Extracted Phrase | Total Count |
|---|---|
| Sam interest | 4 |
| Sam interest becoming | 8 |
| Interest becoming | 4 |
| Interest becoming doctor | 8 |
| Becoming doctor | 4 |

In some embodiments, an appearance count 202 or a count of the number of times an extracted phrase 204 appears proximate to a user devised phrase may be adjusted to arrive at a more refined relevance ranking. Some possible adjustments are as follows:

a) An appearance of the phrase originally input as a user devised phrase is discarded for purposes of the appearance count. For example, if a user devised phrase is ‘Sarbanes Oxley’, an appearance of the phrase ‘Sarbanes Oxley’ or “Oxley Sarbanes’ would not be included or displayed as an extracted phrase on the list of extracted phrases, and its appearance would not be counted for purposes of the appearance count.

b) For example, if the extracted phrase includes more than one word, the count may be multiplied by 2 raised to the power of the number of words in the extracted phrase (proximity appearance count*(2 squared). This adjustment may be referred to in this paper as the multi-word adjustment. If the extracted phrase includes three words, the count may be multiplied by 2 cubed. A rationale for this adjustment may be that the relevance of an extracted phrase is increased by the specificity of the extracted phrase, where the length of the phrase is indicative of its specificity. The ranking of the extracted phrases may then be recalculated using the adjusted appearance count. Other methods of weighting the count to adjust for the number of words in the extracted phrase are possible.

c) If the extracted phrase appears in a file, text, image or other unit of the result set wherein the user-devised search appears in the exact form (other than plural/singular and similar non-significant differences), then the count for the extracted phrase is multiplied by 1.5 Other weights are possible as an adjustment factor for the appearance of the extracted phrase in a hit with the user-devised phrase.

d) If the one or more words in the extracted phrase do not appear in the user-derived phrase, then the count as adjusted in accordance with the calculations above, is further adjusted in accordance with the following function:

Further Adjusted Count=Adjusted Count*(1+(0.5*(X−Y))
Where X is the number of words in the extracted phrase, and Y is the number of words in the extracted phrase that do not appear in the user devised phrase.

For example if the user devised phrase is ‘software product’ and an extracted phrase is ‘product literature’ which has a count of 74, the application of this adjustment formula would be 74*(1+(0.5*(2−1)))=74*1.5, where X would be 2 as the number of words in the extracted phrase, and Y is 1 as the number of words in the extracted phrase that do not appear in the user devised phrase. If a second extracted phrase is ‘software product line’ which has an initial count of 74, the application of this adjustment would be 74*(1+(0.5*(3−1))), where X would be 3 as the number of words in the extracted phrase, and Y would be 1 as the number of words in the extracted phrase that are not the same as the user devised phrase.

e) Erase from the list of extracted phrases, an extracted phrase that includes the same words as another extracted phrase, but that uses such words in a different order. For example, under this adjustment, one of terms ‘reinforced concrete’ and ‘concrete reinforced’ would be deleted. The adjusted counts for each of such extracted terms would be added together and would be used in or assigned to the ranking of the remaining term that is left in the list of extracted phrases.

f) If there are two extracted phrases that contain only two words and both (i) the second word of one of such phrases is the same as the first word of another of such phrases, and (ii) the two extracted phrases have the same unadjusted counts, then such two extracted phrases may be combined into a single extracted phrase that includes all the non-redundant words of the extracted phrases, and the unadjusted count of the combined phrases may be assigned to such extracted phrase that remains on the list of relevant phrases.

g) If there appears in an extracted phrase that has at least two words, of which at least one of such words is a member of a class of words which are designated for purposes of this paper as a framework word, multiply the count of such phrase by (50/(2^{(number of words contained in the extracted phrase)}*number of framework words in the phrase). For example, assume a user devised phrase is ‘air conditioning’, and extracted phrases from the result set include ‘climate control’ that has a pre-adjusted count of 60 and ‘compare prices’ that has a pre-adjusted count of 43, where the words climate, control and prices are all framework words, but the word compare is not a framework word. The adjustment for ‘climate control’ would be 60*(50/8), where 8 is 2 raised to the power of 2 for the number of framework words in the phrase, times 2 for the number of words contained in the extracted phrase, whereas the adjustment for ‘compare price’ is 43*(50/4) where 4 is 2 raised to the first power for the number of framework words in the phrase, multiplied by 2 for the number of words in the extracted phrase. On implication of this adjustment formula is that framework words may be more indicative of relevance or contextual meaning when they appear in combination with regular words rather than in combination with other framework words.

A non-exclusive list of framework words or stems of framework words is as follows:
Guideline, Institute, Govern-, Committee, Biograph-, Autobiography, Board, Manag-, Code, Principl-, Principal, Practice, Standard, Encyclopedia, Gases, Chang-, Program, Engine, Panel, Plan-, Center-, Century, Environment-, Science, Initiative, News, Organization-, Group-, Emission-, Storage-, Cycle-, Analysis, Dictionary meaning, Meaning, Interpret-, Power, Plant, Air, Atom-, Economic-, -technolog-, Information, Term, Water, Service-, Health, Public, Association-, Staff-, Faculty-, Service-, Association-, Industr-
Other framework words are possible.

While framework words may have numerous unifying characteristics, one of such is that they frame or define a significant contextual link or indicator to one or more words that they are conceptually connected to. For example, the word ‘institution’, when combined with another word, may indicate a contextual meaning of the connected word. For example a government institution, an environment institution or an educational institution may be indicative of a high relevance of the phrases. These phrases may serve as strong candidates for being part of a displayed list of relevant extracted terms and for adding to a search string.

g) In some embodiments, the appearance counts of synonymous terms may be combined for purposes of relevance ranking. For example and in some embodiments, the phrases ‘tax presence’ and ‘residence tax’ may be deemed to be synonymous. The proximity appearance count for the two phrases may be combined for purposes of relevance ranking, and only one of the synonymous terms may be displayed to a user in a list of extracted phrases. In some embodiments, even though only one of such synonymous phrases may be displayed, both of the phrases may be added to the refined search string by way of an initial AND connector, and then coupled together in a parenthesis with an OR separating them, as follows: (tax presence OR residence tax) AND {User devised phrase}. A further explanation of the process of identifying synonymous phrases is presented in this paper. Other processes for identifying similar or synonymous phrases are possible.

h) In some embodiments, an appearance count may be reduced to account for duplications caused by synonymous words in a single extracted phrase. For example, a phrase regarding a ‘corporation's corporate counsel’ may include the two synonymous words corporation and corporate. In such case the phrase would be reduced to ‘corporate counsel’ and the appearance count would remain as it was calculated for the phrase when it included three words.

Reference is made to FIG. 2B, a table of extracted phrases whose rankings have been adjusted for display to a user, and further showing synonymous phrases grouped together into categories or hidden from view of a user, in accordance with an embodiment of the invention.

In some embodiments, once these or other adjustments are made to the appearance counts of extracted phrases, the extracted phrases may be sorted and ranked in order of their relevance.

In some embodiments, the ranked and extracted phrases may be presented to or displayed for the user, and the user may select one or more of the extracted phrases for inclusion in or merging with a refined or focused search string. Such selection may be accomplished by for example clocking a mouse or pointer on a box next to the selected phrase or through other actions. In some embodiments, and where there are synonymous extracted phrases 204, the extracted phrase 204 that is displayed for possible selection by the user from among the synonymous phrases may be the extracted phrase 204 with the highest relevance ranking after giving effect to some or all of the adjustments, while the lower ranked synonymous extracted phrase 208 may be hidden or displayed in a smaller size. Such refined search string may include for example the original term, couple by way of an AND connector to the one or more terms selected by the user from the extracted phrases. Synonyms of a selected extracted phrase may be included in the refined search term by way of an OR connector as follows {user devised phrase} AND ({selected extracted term as displayed for user} OR {synonym of selected extracted phrase as may not have been displayed to user}). In some embodiments, more that one extracted phrase or sets of extracted phrases can be added to the refined search string.

In some embodiments a search using the refined search string may be executed on the initial search set. In some embodiments a search using the refined search string may be executed on the whole or part of the whole electronic data base.

In some embodiments, some or all of the extracted phrases from a result set may be loaded into a data base such as an array or other assembly of such phrases in an electronic format. The extracted phrases may be associated with for example their relevance ranking as may have been collected or calculated and adjusted in accordance with some or all of the processes set forth elsewhere in this paper.

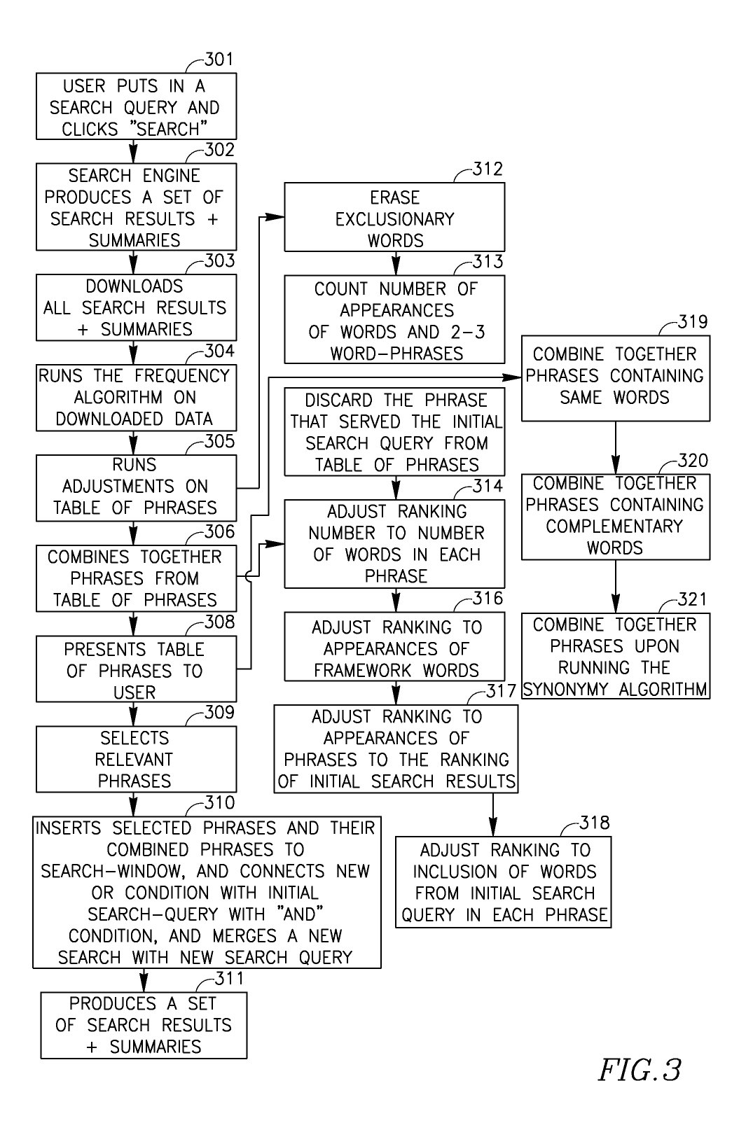

Reference is made to FIG. 3, a flow chart of a method of adjusting rankings of extracted words or phrases, in accordance with an embodiment of the invention. In block 301 a user may execute a search of a data base with a first search phrase that may be deemed a user devised search phrase. In block 302, the search engine may find search results or their summaries that contain the user devised search phrase. In block 303, a processor may load some or all of the result set into a memory, such as a temporary memory file. In block 304 a processor may calculate a frequency of the appearance of words or phrases in the result set. In block 312, a processor may exclude some or all inert or exclusionary words, such as for example words with little or no contextual meaning or relevance from the result set. In block 313, the processor may count the number or appearances in the result set of words or phrases, and may associate such count with the respective phrases or words, and may load the extracted words or phrases into a table, sorted by their associated appearance count.

Block 305 may begin the process of adjusting the ranking of the extracted phrases. In block 314, extracted phrases that are the same as the user devised search term may be discarded along with their appearance counts. In block 315, the appearance count may be adjusted to account for the number of words in the extracted phrase as is described in sub-paragraph b) above. In block 316, the appearance count of phrases that include framework words may be adjusted as is described in sub-paragraph g) above. In block 317, appearance count may be further adjusted to account for extracted phrases that appear in a file wherein is found the exact user devised search phrase, as is described in sub-paragraph c) above. In block 318, the appearance count may be further adjusted to account for words in the extracted phrase that do not appear in the user derived phrase, as is described in sub-paragraph d) above.

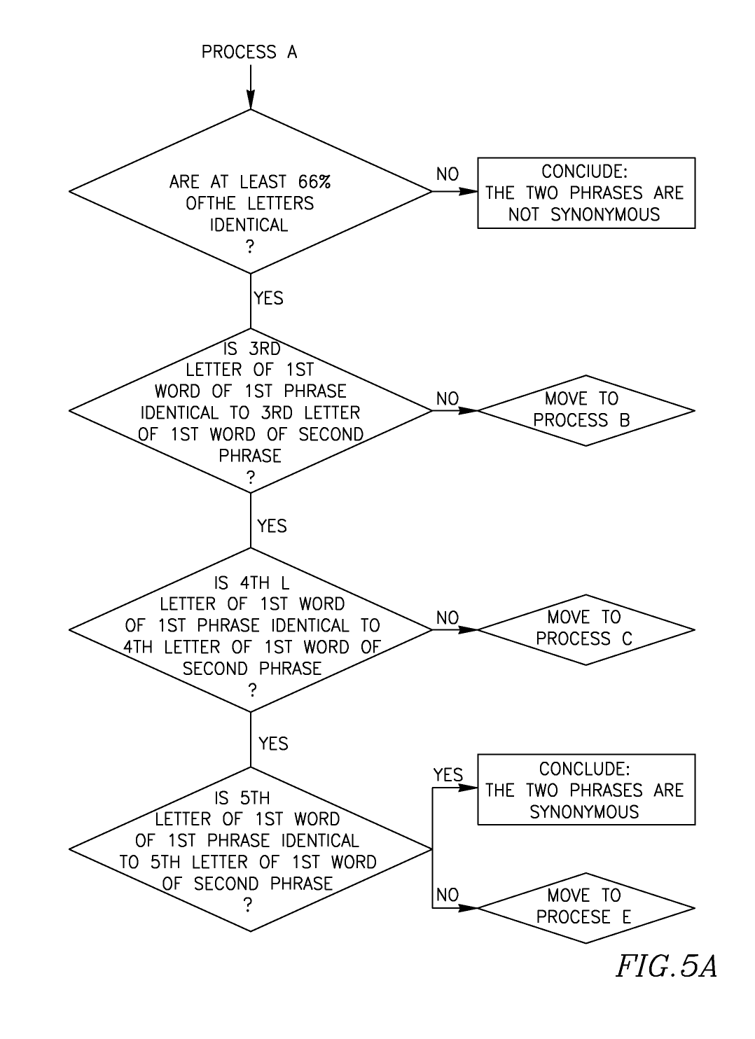

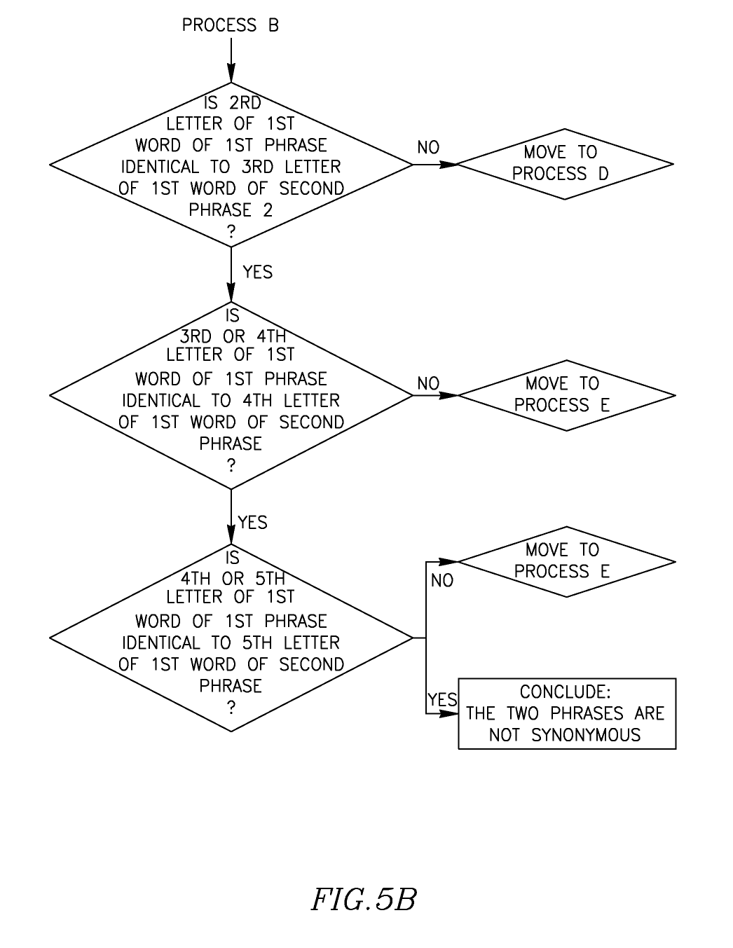

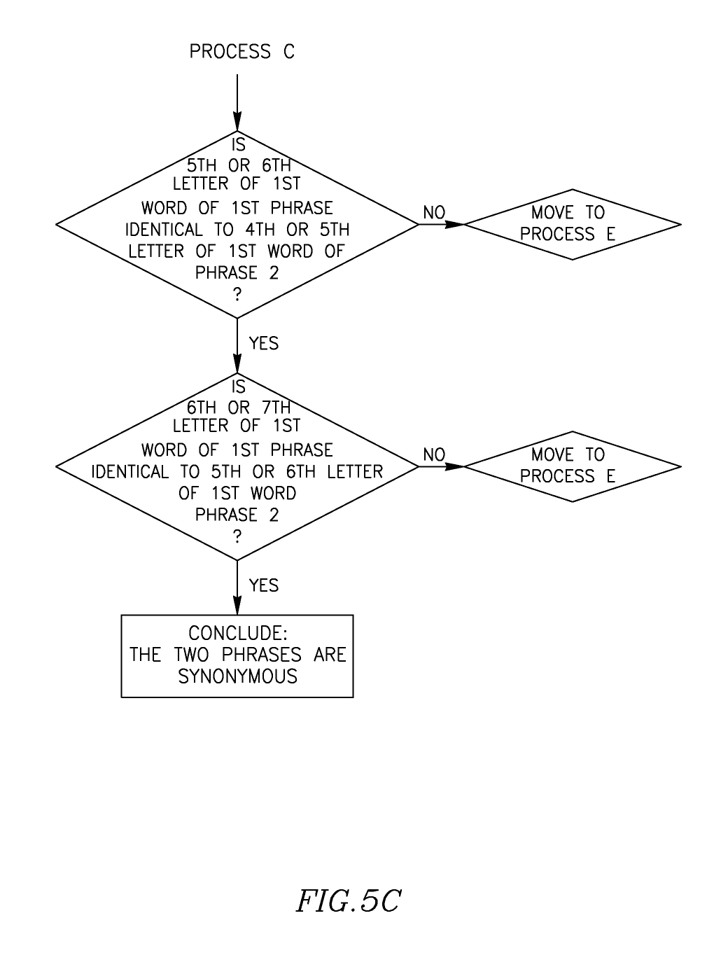

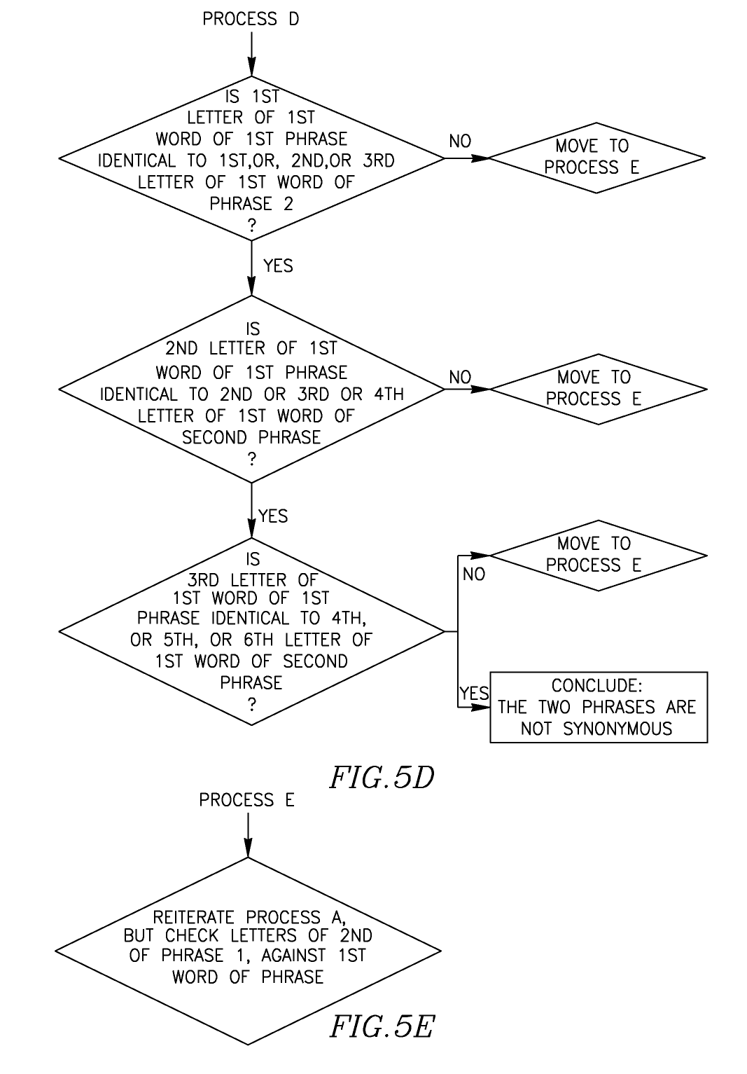

A method may then return to block 306, where extracted phrases that contain the same or similar terms are combined. For example and in block 319, extracted phrases that contain the same root words may be combined as is described in sub-paragraph h) above. In block 320, extracted phrases that contain overlapping first or second words may be combined as is described in sub-paragraph f) above. In block 321, there may be combined synonymous extracted phrases, as is described in sub-paragraph g) above and in the description of FIG. 5 below.

A method may then return to block 308, where the extracted phrases, along with their adjusted relevance rankings may be presented or display for a user. In block 309, the user may select from among the presented extracted phrases. In block 310, the selected extracted phrases along with their synonymous phrases, if any may be added to the user derived search phrase with for example an AND Boolean connector, and the search may be re-run using this refined or expanded search string. In block 311, a new result set may be produced.

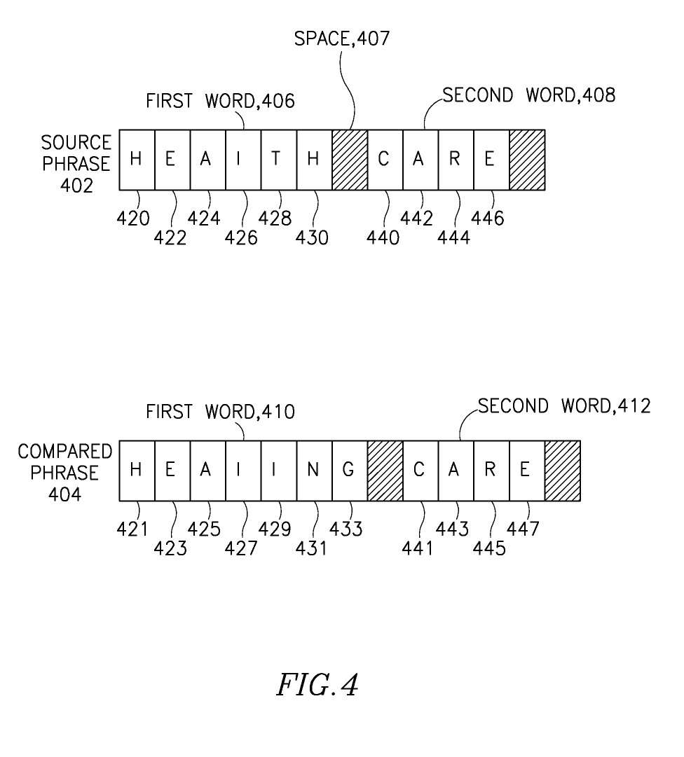

Reference is made to FIG. 4, an array into which words and letters of a source phrase and a compared phrase may be loaded, in accordance with an embodiment of the invention. A determination of whether a phrase which may be deemed for purposes of this explanation, a source phrase, is synonymous with another phrase, which may be deemed for purposes of this explanation, a compared phrase, may be initiated by loading the two phrases, on a letter by letter basis into a set of arrays or other data storage or memory structure, such that the letters of the first word 406 of the source phrase 402 and the second word 408 of the source phrase 402 are loaded into first array 403. Similarly, the letters of the first word 410 and second word 412 of the compared phrase 404 may be loaded into a second array 405 or other data structure that may allow comparison of letters and their positions between two phrases. In some embodiments, a blank 407 or space holder may separate the two words of each phrase.

In operation, a compared phrase 404 may be found to be synonymous with a source phrase 402 if (i) there is an identity of letters between the two phrases that exceeds a pre-defined percentage, and (ii) if there is present a triplet or ordered set or series of for example at least three letters in a root portion of a word of the source phrase 402 that is also present in a root portion of a word of the compared phrase 404. In some embodiments, a determination that these two conditions are met may be executed as follows:

A comparison of the identity of the letters in the source phrase 402 and the compared phrase 404 may be undertaken by for example a processor. A sum or proportion of the letters and the frequency of their appearance in the source phrase 402, as compared with the letters and their frequency of appearance in the compared phrase 404, but without regard to the position of such letters in such phrases may be calculated. If the letters and their frequency as appear in the source phrase 402 and that also appear in the compared phrase is less than a pre-defined proportion or amount, such as for example 66% or 70%, then the source phrase 402 and the first compared phrase may be deemed to be not synonymous for purposes of this determination. A comparison may then be made between the source phrase 402 and a second compared phrase, and third compared phrase, until either all of the extracted phrases have been compared to a source phrase 402, or a compared phrase 404 is found that has an identity of letters to the source phrase 402 equal to or greater than a pre-defined percent such as 66% or 70%. Other percentages may be used, and other orders of comparison may be used.

In some embodiments, if no compared phrase 404 is found that has an identity of letters to a particular source phrase 402 that exceeds a pre-defined level, then the process may be re-executed where a second extracted phrase may be adopted as a new source phrase, and its letters may be compared to the other extracted phrases which serve as compared phrases 404. In some embodiments, some or all extracted phrases, other than those that are found to be synonymous in the course of this process, may be evaluated as source phrases 402, whose letters are compared for against the letter of other extracted phrases to determine the proportion of the similarity of letters.

Once a compared phrase 404 is found to have an identity of letters with a source phrase 402 that is above a threshold level, a search for an ordered triplet in a root section of a source phrase 402 and in a compared phase 404 may be undertaken. In some embodiments, such as search may select a third letter 424 of a first word 406 of a source phrase 402, and compare such third letter 424 to a third letter 425 of a first word 410 of compared phrase 404. If the letters are not identical, third letter 424 is then compared to second letter 423 of first word 410 of compared phrase 404. If such letters are not identical, third letter 424 is compared to first letter 421 of first word 410 of compared phrase 404.

If none of such comparisons is successful, i.e. yields a same letter between third letter 424 and any of the third letter 425, second letter 423 or first letter 421 of the first word 410 of the compared phase 404, then, compare the second letter 422 of first word 406 of source phrase, 402, with the third letter 425 of first word 410 of compared phrase 404. If the letters are not identical, 2nd letter 422 is then compared to second letter 423 of first word 410 of compared phrase 404. If such letters are not identical, second letter 422 is compared to first letter 421 of first word 410 of compared phrase 404.

If none of such comparisons is successful, i.e. yields a same letter between second letter 422 and any of third letter 425, second letter 423 or first letter 421, then, compare the first letter 420 of first word 406 of source phrase, 402, with the third letter 425 of first word 410 of compared phrase 404. If the letters are not identical, 1st letter 422 is then compared to second letter 423 of first word 410 of compared phrase 404. If such letters are not identical, 1st letter 420 may be compared to first letter 421 of first word 410 of compared phrase 404.

If none of such comparisons is successful, i.e. yields a same letter between third letter 424 and any of third letter 425, second letter 423 or first letter 421, perform the same comparison of third letter 425 of first word 406 of the source phrase 402 to third letter 445 of the second word 412 of compared phrase 404. If such comparison is not positive, proceed to second letter 443 and first letter 441 of second word 412 of compared phrase 404. This process looks for a similar ordered triplet between first word 06 of source phrase 402 and second word 412 of compared phrase 404, to account for the possibility that the words in compared phase 404 may be synonymous with source phrase 402, but in a reversed order.

If none of such comparisons are positive, conclude that source phrase 402 is not synonymous with this compared phrase and proceed to evaluate a next compared phrase against this source phrase 402.

If any of the comparisons of third letter 424 above were positive, compare fourth letter 426 of first word 406 or source phrase 402 to the letter of compared phrase 404 following the letter where the positive comparison was found. For example, if third letter 424 is the same as second letter 423 of first word 410 of compared phrase 404, then compare fourth letter 426 of first word 406, to third letter 425 of first word 410 of compared phrase 404. This comparison will determine if the letters following the first match are also a match.

If no such match had been found, a comparison would be made between the fourth letter 426 and letter 427, which is the letter after the letter following the matching letter 423. If such match is negative proceed to compare the fifth letter 28 of first word 406 of source phrase 402, with the letter following the first matching letter of the first word 410 of the compared phrase 404. If all such comparisons are negative, we may conclude that the source phrase 402 and the compared phrase 04 are not synonymous.

In some embodiments, comparing not only the first letter following the first matching letters, but also the second and third letter following the matching letters, allows for the presence of one or even two intervening letters that may appear within an ordered triplet, but that do not negate the similarity of such ordered triplet to an ordered triplet that does not include the intervening letter, such as may be found in the source phrase.

In some embodiments, if there is found a positive comparison between the letters following the first or second matching letters in the source phrase and in the compared phrase, but either the source-phrase word or the compared phrase word do not have any more letters, after the matching letters, then, comparison should go back to comparing the second letter of the source-phrase word, with the previous-to-the-first matching letter of the compared-phrase word.

If an ordered triplet is found between three letters in a root position of either the first word 406 or the second word 408 of the source phrase 402, and the first word 410 of the compared phrase 404, then proceed to check the second word 412 of the compared phrase 404 with the word of the source phrase wherein the ordered triplet was not found in the prior checks. In this comparison, begin with the second letter 442 of the yet unchecked word 408 of the source phrase 402, and compare it to the second letter 443 of the second word 412 of the compared phrase 404. Perform the search as described above to see if an ordered triplet is found between letters 442, 444 to 46 and any three ordered letters from among letters 441, 443, 445, 447, 449.

If ordered triplets in each of the words in the source phrase 402 match ordered triples in each of the words of the compared phrase, then we can conclude that the phrases are synonymous. In such case, the [[adjusted]] counts of the two synonymous phrases may be added together, but only one of the synonymous phrases needs to appear on the displayed list. The extracted phrases may be re-ranked or sorted to account for the adjusted count. The non-appearing phrase may, however, be connected by an OR to its synonym for purposes of the refined search string.

A search for other synonymous phrases may continue where a next or subsequent extracted phrase becomes a source phrase and is compared to the remaining or other phrases on the list.

In some embodiments, a list of search terms and their possible synonyms may be loaded, stored or assembled into a data base that may be accessed in future searches by the same or other users. Likewise, a list of extracted phrases that were associated with or found in a result set of a search may be saved in a data base, and such list may be presented to this or other users when the same or synonymous phrases are searched on the data base.

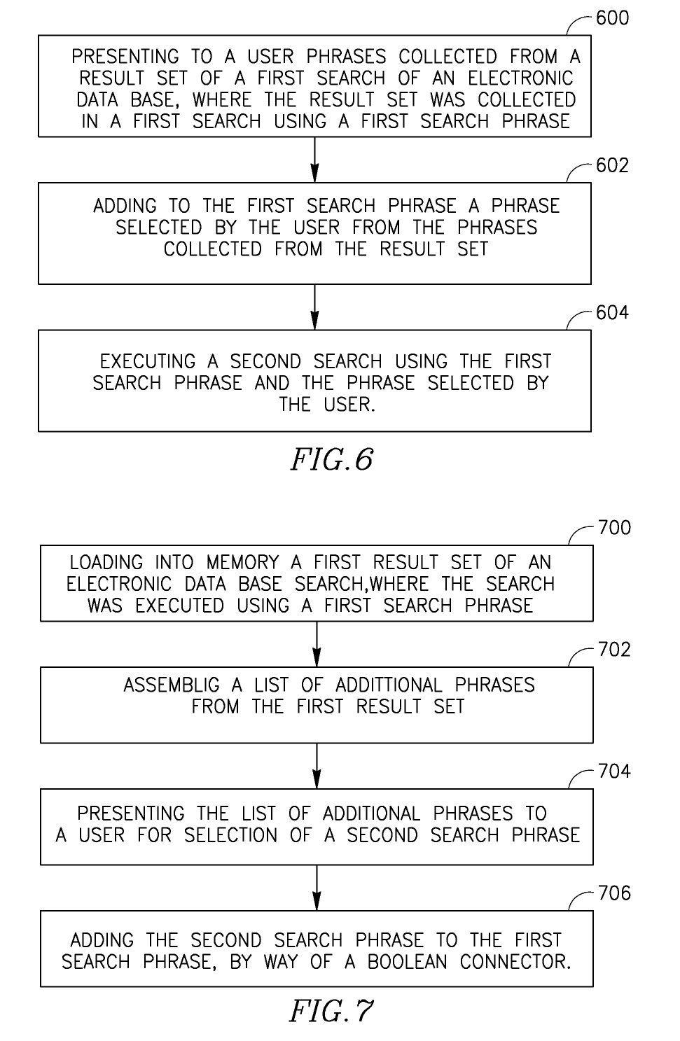

Reference is made to FIG. 6, a flow chart in accordance with an embodiment of the invention. In some embodiments of the invention, and in block 600 a method may include presenting to a user a phrase collected from a result set of a first search of an electronic data base, where the first search used a first search term. In block 602, a phrase that was selected by a user from among the phrases collected from said result set, may be added to said first search term, by way of for example a Boolean connector. In block 604, a search may be re-executed on the same or another data base including as search terms the first search term and the selected search term.

In some embodiments the result set of the first search may be loaded into a memory, and phrases may be extracted from the loaded result set. In some embodiments, the phrases collected from the result set may be ranked by relevance to the first search term or to the documents or files that were included in the result set.

Reference is made to FIG. 7, a flow chart in accordance with an embodiment of the invention. In block 700 there may be loaded into a memory a first result set of an electronic data base search, where the search was executed using a first search phrase. In block 702, there may be assembled a list of additional phrases from the first result set that was created by the first search. In block 704, there may be presented to a user a selection of extracted phrases from the first result set, and the user may select from among the extracted phrases those phrases that match his intended search topic. In block 706, there may be added to the first search phrase the selected one or more search phrases by way of for example a Boolean connector.

It will be appreciated by persons skilled in the art that embodiments of the invention are not limited by what has been particularly shown and described hereinabove. Rather the scope of at least one embodiment of the invention is defined by the claims below.

I claim:

1. A method comprising:
loading into a memory a result set of an electronic data base search, said search executed using a first search phrase;
assembling a list of additional phrases from said result set;
presenting said list to a user for selection of a second search phrase; and
adding said second search phrase to said first search phrase, said adding with a Boolean connector.

2. The method as in claim 1, wherein said electronic data base search comprises a first electronic data base search, and comprising performing a second electronic data base search using said second search phrase and said first search phrase.

3. The method as in claim 2, wherein said second electronic data base search is executed on said first result set.

4. The method as in claim 2, wherein said second electronic data base search is executed on said electronic data base.

5. The method as in claim 1, wherein said assembling comprises identifying words in said first result set that are proximate to said first search phrase.

6. The method as in claim 5, wherein said identifying words comprises identifying phrases of words that are proximate to said first search phrase, said phrases being of one to three words in length.

7. The method as in claim 1, wherein said assembling comprises ranking an additional phrase on said list according to a number of times said additional phrase appears in said result set proximate to said first search term.

8. The method as in claim 1, wherein said assembling comprises identifying at least additional phrases that are synonymous to each other.

9. The method as in claim 8, comprising summing a relevance ranking of said at least two synonymous phrases.

10. The method as in claim 9, comprising assigning a title to said at least two synonymous phrases based on a word of a first phrase of said two synonymous phrases, said first phrase having a highest relevance ranking from among said at least two synonymous phrases.

11. The method as in claim 9, wherein said adding comprises adding as said second search phrase at least two of said at least two synonymous phrases, and wherein said adding with a Boolean connector comprises adding said second phrase to said first phrase with an AND connector, and comprising connecting said at least two synonymous phrases to each other with an OR connector.

12. The method as in claim 1, comprising excluding from said list phrases that are synonymous with said first search phrase.

13. The method as in claim 1, comprising adding to said first search phrase with an OR connector phrases from said first result set that are synonymous with said first search phrase.

14. The method as in claim 1, wherein said first result set is derived from summaries of texts in said electronic data base search.

15. The method as in claim 1, comprising assembling said list of additional search phrases from said first result set and from a predefined compendium of search phrases.

16. A method of determining that a first phrase is synonymous with a second phrase comprising:
determining if a number of identical letters in said first phrase and said second phrase is above a pre-defined limit;
if, said number is above said pre-defined limit, determining if an ordered letter group in said first phrase matches an ordered letter group in said second phrase.

17. The method as in claim 16, said determining if an ordered letter group in said first phrase matches an ordered letter group in said second phrase, comprises determining if an ordered letter group of at least three letters in said first phrase matches an ordered letter group of at least three letters in said second phrase.

18. The method as in claim 17, wherein said ordered letter group in said first phrase comprises at least one intervening letter that is not found in said ordered letter group in said second phrase.

19. A method comprising:
presenting to a user phrases collected from a result set of a first search of an electronic data base, said first search using a first search phrase;
adding a phrase selected by said user from said phrases collected from said result set, to said first search phrase;
executing a second search using said first search phrase and said phrase selected by said user.

20. The method as in claim 19, wherein said executing said second search comprises executing said second search on said result set.
